(19) United States
(12) Patent Application Publication
(10) Pub. No.: US 2024/0352160 A1
(43) Pub. Date: Oct. 24, 2024

(54) MATERIAL FUNCTIONALIZED WITH AN ALIPHATIC POLYAMINE

(71) Applicant: UNIVERSITÉ DE FRANCHE-COMTÉ, BESANCON (FR)

(72) Inventors: Guillaume HERLEM, BESANCON (FR); Yaelle ROINA, VILLEPARISIS (FR)

(21) Appl. No.: 18/718,539

(22) PCT Filed: Dec. 14, 2022
(86) PCT No.: PCT/EP2022/085937

§ 371 Date: Jun. 11, 2024

(30) Foreign Application Priority Data
Dec. 15, 2021 (FR) 2113559

(51) Int. Cl. C08F 8/32; C01B 21/064; C01B 32/159; C01B 32/174

(52) U.S. Cl. CPC C08F 8/32; C01B 21/0648; C01B 32/159; C01B 32/174; C01B 2202/02; C01P 2002/82

(57) ABSTRACT

The present invention relates to a material, in particular a fluorocarbon polymer, functionalized by an aliphatic polyamine selected from aliphatic diamines having two primary amines and aliphatic triamines having two or three primary amines, or by a phosphoramide, to the method for preparing same and to the uses thereof. The invention also relates to the use of a composition of an alkali metal and such an aliphatic polyamine for the preparation of a material, in particular a fluorocarbon polymer, which is functionalized.

The subject of the present invention is a material, in particular a fluorocarbon polymer, functionalized by an aliphatic polyamine selected from aliphatic diamines having two primary amines and the aliphatic triamines having two or three primary amines, or by a phosphoramide, its preparation method and its uses.

The invention also concerns the use of a composition of an alkali metal and of such an aliphatic polyamine for the preparation of a material, in particular a functionalized fluorocarbon polymer.

The fluoropolymers have unique qualities that make them essential in many application sectors. They feature excellent non-stick properties and significantly reduce rubbing and friction. They resist corrosion as well as extreme temperatures, do not conduct electricity and do not absorb water.

The non-stick properties, resistance, chemical inertia, anti-adhesion, durability and biocompatibility of fluoropolymers make this type of plastic an essential ally of the medical profession, used by the medical device industry in numerous applications. These materials have been adopted in particular in the manufacture of implants, vascular grafts, catheters, capillary tubes, but also in the packaging of medical and pharmaceutical products.

However, these qualities, in particular this chemical inertia, can also prove to be disadvantages, when it becomes necessary to functionalize, for example with molecules of interest, these fluoropolymers.

The fluorocarbon polymers may, nonetheless, be sensitive to alkali metals. In contact with an alkali metal, these polymers are likely to undergo an irreversible transformation with elimination of the corresponding fluoride. The dissolution of alkali metals in liquid ammonia is known from the prior art, but requires permanent condensation of the solvent at −40° C. (ammonia boils at −33° C. under 1 bar). For example, the reactivity of PTFE with sodium in liquid ammonia has already been applied in the past but requires secure infrastructures linked to the handling of a liquefied gas that is very irritating and can be explosive.

A composition has now been developed comprising an alkali metal and a specific aliphatic polyamine making it possible to chemically modify a material, in particular a fluorocarbon, quasi-chemically inert polymer, and this under mild conditions, in particular at room temperature and standard pressure. This functionalization, however, makes it possible to preserve the intrinsic mechanical properties of said material.

This method for processing the material, in particular a fluorocarbon polymer, is simple to implement, because it involves few chemical compounds, without irritating, toxic, and/or explosive solvents, and under normal conditions of temperature and pressure. This method is therefore economically and environmentally advantageous.

Furthermore, this modification allows the functionalization of the material, in particular of a fluorocarbon polymer, always under mild conditions, in particular at room temperature and standard pressure. This functionalization has the advantage of allowing said material to retain its intrinsic mechanical properties. This functionalization is in addition easy, due to the presence on the surface of the modified material of free and reactive amine groups.

Thus, according to a first aspect, the invention concerns a material selected from the fluorocarbon polymers, the aromatic carbon materials and the boron-based ceramic materials, in which:
all or part of the —F atoms for the fluorocarbon polymers is substituted by;
a part of the carbon atoms for aromatic carbon materials carries; and
a part of the boron atoms for boron-based ceramic materials carries;
   an aliphatic polyamine selected from the aliphatic diamines having two primary amines and the aliphatic triamines having two or three primary amines, or by a phosphoramide.

Thus, as defined above, a polyamine is called so, with the prefix «poly», because it is a compound comprising more than one amine group. Consequently, the aliphatic polyamine according to the invention is not polymerized. And said aliphatic polyamine is not polymerized either before reaction with the material or once said material is functionalized by said aliphatic polyamine.

By «all or part of the —F atoms of the fluorocarbon polymers is substituted by», is meant in particular that all or part of the —F atoms of the fluorocarbon polymers is replaced by the aliphatic polyamine or the phosphoramide. Thus, in particular, all or part of the C—F bonds of the fluorocarbon polymers are replaced by a covalent bond between said carbon atoms and the aliphatic polyamine or phosphoramide.

By «a part of the carbon atoms for aromatic carbon materials carries», is meant in particular that a part of the carbon atoms of the aromatic carbon material is substituted by (in the sense of forming a covalent bond with) the aliphatic polyamine or the phosphoramide.

Likewise, by «a part of the boron atoms for the boron-based ceramic materials carries», is meant in particular that a part of the boron atoms of the boron-based ceramic material carries (in the sense of forming a covalent bond with) the aliphatic polyamine or the phosphoramide.

According to a particular embodiment, the material selected from fluorocarbon polymers is not a polytetrafluoroethylene (PTFE).

According to a particular embodiment, the aliphatic polyamine is not the ethylenediamine.

According to a particular embodiment, the material selected from the fluorocarbon polymers is not a polytetrafluoroethylene (PTFE), and the aliphatic polyamine is not the ethylenediamine.

According to a particular embodiment, the material is not a polytetrafluoroethylene (PTFE) if the aliphatic polyamine is the ethylenediamine.

According to a particular embodiment, the aliphatic polyamine is not the ethylenediamine if the material is a polytetrafluoroethylene (PTFE).

According to a particular embodiment, the invention concerns a material selected from the fluorocarbon polymers, the aromatic carbon materials and the boron-based ceramic materials, in which:
a part of the carbon atoms for aromatic carbon materials carries; and
a part of the boron atoms for the boron-based ceramic materials carries;
   an aliphatic polyamine selected from the aliphatic diamines having two primary amines and the aliphatic triamines having two or three primary amines, or by a phosphoramide.

According to a particular embodiment, the invention concerns a material selected from the fluorocarbon polymers, the aromatic carbon materials and the boron-based ceramic materials, in which:
all or part of the —F atoms for the fluorocarbon polymers is substituted by;
a part of the carbon atoms for aromatic carbon materials carries; and
a part of the boron atoms for the boron-based ceramic materials carries;
   an aliphatic polyamine selected from the aliphatic diamines having two primary amines and the aliphatic triamines having two or three primary amines, or by a phosphoramide.

More generally, the aliphatic polyamine is selected from the aliphatic polyamines capable of dissolving and chelating an alkali metal as defined below. This dissolution and chelation of the alkali metal by said aliphatic polyamine generally allows the formation of solvated electrons, typically in the form of an intense blue solution.

The material selected from the fluorocarbon polymers, the aromatic carbon materials and the boron-based ceramic materials can for example be substituted by an aliphatic polyamine selected from the polyamines carrying more than three primary amines and polyamines of the H₂N—(CH₂—CH₂—NH)ₙ—CH₂—CH₂—NH₂ type, with n ranging in particular from 2 to 10.

According to a particular embodiment, the invention concerns a material as defined above, which is a fluorocarbon polymer, all or part of the —F atoms of which are substituted by an aliphatic polyamine selected from the aliphatic diamines having two primary amines and the aliphatic triamines having two or three primary amines, or by a phosphoramide.

The fluorocarbon polymer may in particular be a perfluorocarbon polymer or a hydrofluorocarbon polymer. According to a particular embodiment, the invention concerns a material as defined above, which is an aromatic carbon material, in which part of the carbon atoms for aromatic carbon materials carrying an aliphatic polyamine selected from the aliphatic diamines having two primary amines and the aliphatic triamines having two or three primary amines, or by a phosphoramide.

The aromatic carbon material may in particular be graphene, one or more carbon nanotubes, or fullerene.

According to a particular embodiment, the invention concerns a material as defined above, which is a boron-based ceramic material, in which part of the boron atoms for aromatic carbon materials carry an aliphatic polyamine selected from the aliphatic diamines having two primary amines and the aliphatic triamines having two or three primary amines, or by a phosphoramide.

The boron-based ceramic material may in particular be a boron nitride.

According to a particular embodiment, the aliphatic polyamine has the following formula (A):

H₂N—R (A),

in which R is a linear or branched C₂-C₁₂ alkyl, and:
R is substituted by one or two —NH₂ groups, or

R is substituted by a —NH₂ group, and one of the carbon atoms of R is replaced by a nitrogen atom.

According to a particular embodiment, R is a linear or branched C₂-C₁₂ alkyl, substituted by one or two —NH₂ groups, in particular an —NH₂ group.

According to a particular embodiment, R is a linear C₂-C₁₂ alkyl, substituted by an —NH₂ group, in particular on the terminal carbon atom, the aliphatic polyamine of formula (A) being more particularly of the following formula (Aa): H₂N—CH₂—CH₂—NH₂, ou H₂N—CH₂—CH₂—CH₂—NH₂, even more particularly H₂N—CH₂—CH₂—NH₂.

According to a particular embodiment, R is a linear or branched C₂-C₁₂ alkyl, substituted by an —NH₂ group, one of the carbon atoms of R being further replaced by a nitrogen atom, the aliphatic polyamine of formula (A) being more particularly of the following formula (Aa):

H₂N—CH₂—CH₂—NH—CH₂—CH₂—NH₂.

According to a particular embodiment, the aliphatic polyamine is selected from ethylenediamine, 1,3-diaminopropane, and diethylenetriamine.

According to a particular embodiment, the invention concerns a material selected from the fluorocarbon polymers, the aromatic carbon materials and the boron-based ceramic materials, in which:
all or part of the —F atoms for the fluorocarbon polymers is substituted by;
a part of the carbon atoms for aromatic carbon materials carries; and
a part of the boron atoms for the boron-based ceramic materials carries;
a phosphoramide.

According to a particular embodiment, the phosphoramide is selected from the phosphoramides of the following formula (B):

XₐX_{b}P(═O)X_{c} (B)

in which:
Xₐ and X_{b} are selected independently from the —NRₐRb groups, where Rₐ and R_{b} are independently selected from H and the linear or branched C₁ to C₆ alkyls, Xₐ and X_{b} being in particular —NMe₂;
X_{c} is selected from the —NRₐR_{b} groups, where Rₐ and R_{b} are independently selected from H and linear or branched C₁ to C₆ alkyls, the groups —OH and —OR_{c}, where R_{c} is a linear or branched C₁ to C₆ alkyl, X_{c} being in particular —NMe₂.

Thus, the nitrogen or oxygen of the groups Xₐ, X_{b} and X_{c} is linked to phosphorus.

In particular, the phosphoramide is the hexamethylphosphoramide (HMPA).

Without wishing to be limited to a particular theory, phosphoramide is for example linked to the fluorocarbon polymer via a carbon (from the fluorocarbon polymer)—phosphorus (from the phosphoramide) bond. Thus, in particular, all or part of the C—F bonds of the fluorocarbon polymer are replaced by a covalent bond between said carbon atoms and the phosphoramide, more particularly the phosphorus of the phosphoramide.

Analogously, and still without wishing to be limited to a particular theory, the phosphoramide is for example linked to the aromatic carbon material via a carbon (from the aromatic carbon material)—phosphorus (from the phosphoramide) bond. Thus, in particular, part of the carbon atoms of the aromatic carbon material is substituted by (in the sense of forming a covalent bond with) the phosphoramide, more particularly by the formation of a covalent bond between said carbon atoms and the phosphorus of the phosphoramide.

The modification of the material with a phosphoramide is likely to make the surface of this material, when desired, cytotoxic.

According to a particular embodiment:
the aliphatic polyamine is 1,3-diaminopropane, and the material is PTFE;
the aliphatic polyamine is ethylenediamine or diethylenetriamine, and the material is ePTFE;
the aliphatic polyamine is the ethylenediamine or the diethylenetriamine, and the material is an acidic perfluorosulfonic polymer, for example Nafion;
   the phosphoramide is the hexamethylphosphoramide (HMPA), and the material is PTFE.

According to a particular embodiment, the invention concerns a fluorocarbon polymer as defined above, in which part of the —F atoms is substituted by a group of formula (I):

—NH—R (I),

in which R is a linear or branched C₂-C₁₂ alkyl, and:
R is substituted by one or two —NH₂ groups, or
R is substituted by a —NH₂ group, and one of the carbon atoms of R is replaced by a nitrogen atom.

According to a particular embodiment, the invention relates to an aromatic carbon material as defined above, a part of the carbon atoms carries a group of formula (I):

—NH—R (I),

in which R is a linear or branched C₂-C₁₂ alkyl, and:
R is substituted by one or two —NH₂ groups, or
R is substituted by a —NH₂ group, and one of the carbon atoms of R is replaced by a nitrogen atom.

According to a particular embodiment, the invention concerns a boron-based ceramic material as defined above, in which part of the boron atoms carry a group of formula (I):

—NH—R (I),

in which R is a linear or branched C₂-C₁₂ alkyl, and:
R is substituted by one or two —NH₂ groups, or
R is substituted by a —NH₂ group, and one of the carbon atoms of R is replaced by a nitrogen atom.

According to a particular embodiment, the invention concerns a fluorocarbon polymer as defined above, in which part of the —F atoms is substituted by a group of formula (II):

—P(═O)XₐX_{c} (II),

in which:
Xₐ is selected from the —NRₐR_{b} groups, where Rₐ and R_{b} are independently selected from H and the linear or branched C₁ to C₆ alkyls, Xₐ being in particular —NMe₂;
X_{c} is selected from the —NRₐR_{b} groups, where Rₐ and R_{b} are independently selected from H and linear or branched C₁ to C₆ alkyls, the groups —OH and —OR_{c,} where R_{c} is a linear or branched C₁ to C₆ alkyl, X_{c} being in particular —NMe₂.

According to a particular embodiment, the invention concerns an aromatic carbon material as defined above, a part of the carbon atoms carries a group of formula (II):

—P(═O)XₐX_{c} (II),

in which:
Xₐ is selected from the —NRₐR_{b} groups, where Rₐ and R_{b} are independently selected from H and the linear or branched C₁ to C₆ alkyls, Xₐ being in particular —NMe₂;
X_{c} is selected from the —NRₐR_{b} groups, where Rₐ and R_{b} are independently selected from H and linear or branched C₁ to C₆ alkyls, the groups —OH and —OR_{c,} where R_{c} is a linear or branched C₁ to C₆ alkyl, X_{c} being in particular —NMe₂.

The substitution by said group of formula (I) on the material selected from the fluorocarbon polymers, the aromatic carbon materials and the boron-based ceramic materials can be characterized by one of the techniques well known to those skilled in the art, for example by attenuated total reflectance spectroscopy (IR-ATR, from «Attenuated Total Reflectance Infrared»), X-ray photoelectron spectroscopy (or spectrometry of photoelectrons induced by X rays, XPS or Raman spectroscopy.

According to a particular embodiment, R is a linear or branched C₂-C₁₂ alkyl, substituted by one or two —NH₂ groups, in particular an —NH₂ group.

According to a particular embodiment, R is a linear C₂-C₁₂ alkyl, substituted by an —NH₂ group, in particular on the terminal carbon atom, the group of formula (I) being more particularly of the following formula (Ia): —NH—CH₂—CH₂—NH₂, or —NH—CH₂—CH₂—CH₂—NH₂, even more particularly —NH—CH₂—CH₂—NH₂.

According to a particular embodiment, R is a linear or branched C₂-C₁₂ alkyl, substituted by an —NH₂ group, one of the carbon atoms of R being further replaced by a nitrogen atom, the group of formula (I) being more particularly of the following formula (Ia): —NH—CH₂—CH₂—NH—CH₂—CH₂—NH₂.

According to a particular embodiment, the material is selected from the polytetrafluoroethylene (PTFE), perfluorosulfonic acid polymer (PFSA), for example Nafion, poly (vinyl fluoride) (PVF), poly (vinylidene fluoride) (PVDF), polychlorotrifluoroethylene (PCTFE), perfluoroalkoxy (PFA), fluorinated ethylene propylene (FEP), ethylene tetrafluoroethylene (ETFE), polyethylenechlorotrifluoroethylene (ECTFE), perfluoropolyether (PFPE), perfluoropolyoxetane, and fluoroelastomers, said material being in particular a polytetrafluoroethylene (PTFE), more particularly an expanded polytetrafluoroethylene (ePTFE), or a perfluorosulfonic acid.

According to another aspect, the invention also concerns the use of a composition consisting of or comprising an alkali metal and an aliphatic polyamine selected from the aliphatic diamines having two primary amines and the aliphatic triamines having two or three primary amines, or by a phosphoramide, for the preparation of a material as defined above, in particular a fluorocarbon polymer.

All the embodiments defined previously are also applied here, alone or in combination.

According to another aspect, the invention also concerns the use of a composition consisting of or comprising an alkali metal and an aliphatic polyamine selected from the aliphatic diamines having two primary amines and the aliphatic triamines having two or three primary amines, or by a phosphoramide, for stripping a material selected from the fluorocarbon polymers, the aromatic carbon materials and the boron-based ceramic materials, in particular a fluorocarbon polymer, in particular a fluorocarbon polymer.

All the embodiments defined previously are also applied here, alone or in combination.

According to another aspect, the invention also concerns the use of a composition consisting of or comprising an alkali metal and an aliphatic polyamine selected from the aliphatic diamines having two primary amines and the aliphatic triamines having two or three primary amines, or by a phosphoramide, for the reprocessing of a material selected from the fluorocarbon polymers, the aromatic carbon materials and the boron-based ceramic materials, in particular a fluorocarbon polymer.

All the embodiments defined previously are also applied here, alone or in combination.

According to another aspect, the invention also concerns the use of a composition consisting of or comprising an alkali metal and an aliphatic polyamine selected from the aliphatic diamines having two primary amines and the aliphatic triamines having two or three primary amines, or by a phosphoramide, for the functionalization of a material selected from the fluorocarbon polymers, the aromatic carbon materials and boron-based ceramic materials, in particular a fluorocarbon polymer, in particular an antibacterial or biocompatibilising functionalization.

All the embodiments defined previously are also applied here, alone or in combination.

According to another aspect, the invention also concerns a method for preparing a modified material, in particular as defined above, which comprises a step (i) of bringing into contact a material selected from the fluorocarbon polymers, the aromatic carbon materials and boron-based ceramic materials, in particular a fluorocarbon polymer, with a composition consisting of or comprising an alkali metal and an aliphatic polyamine selected from the aliphatic diamines having two primary amines and the aliphatic triamines having two or three amines primary, or by a phosphoramide, to obtain said material, in particular said polymer in which part of the —F atoms is substituted by said aliphatic polyamine or said phosphoramide.

The material thus obtained is also called modified material.

All the embodiments defined previously are also applied here, alone or in combination.

According to a particular embodiment, the alkali metal is lithium or sodium.

According to a particular embodiment, the step (i) is carried out at a temperature comprised between the melting point and the boiling point of the aliphatic polyamine.

According to a particular embodiment, step (i) is carried out at a temperature comprised between 10° C. and 80° C., in particular at a temperature comprised between 15 and 25° C., in particular around 20° C.

According to a particular embodiment, step (i) is carried out under an inert atmosphere, in particular under argon.

The mass concentration of alkali metal in the aliphatic polyamine is for example about 5 g/L.

The initial material/aliphatic polyamine mass ratio is for example about 0.129.

According to a particular embodiment, the alkali metal/aliphatic polyamine molar ratio is comprised from 0.1 to 0.9, in particular from 0.2 to 0.8, or from 0.3 to 0.7, or from 0.4 to 0.6, this ratio being in particular around 0.5.

According to a particular embodiment, step (i) is followed by a step (ii) of rinsing the material obtained at the end of step (i) with a solvent consisting of or comprising an alcohol, in particular ethanol, this step (ii) being optionally followed by a step (ii′) of rinsing with a solvent consisting of or comprising water.

According to another aspect, the invention also concerns a product capable of being obtained by a method comprising a step (i) of bringing into contact a material selected from the fluorocarbon polymers, the aromatic carbon materials and the boron-based ceramic materials, in particular a fluorocarbon polymer, with a composition consisting of or comprising an alkali metal and an aliphatic polyamine selected from the aliphatic diamines having two primary amines and the aliphatic triamines having two or three primary amines, or by a phosphoramide, to obtain said modified material.

All the embodiments defined previously are also applied here, alone or in combination.

According to another aspect, the invention also concerns a material selected from the fluorocarbon polymers, the aromatic carbon materials and the boron-based ceramic materials, in which:
all or part of the —F atoms for the fluorocarbon polymers is substituted by;
a part of the carbon atoms for aromatic carbon materials carries;
a part of the boron atoms for the boron-based ceramic materials carries;
   an aliphatic polyamine selected from the aliphatic diamines having two primary amines and the aliphatic triamines having two or three primary amines, or by a phosphoramide, all or part of these aliphatic polyamines being further linked, in particular by crosslinking, to a compound of interest independently selected from the polysaccharides, in particular the polysaccharides consisting of or comprising at least one osamine unit, in particular chitosans or chitins, the polymers consisting of or comprising at least one unit comprising a primary or secondary amine, or a lactam, in particular the polyethyleneimines (PEI), in particular linear, branched or dendrimeric polyethyleneimines, the polyvinylpyrrolidones (PVP), and the antibacterial compounds.

As an illustrative guide, the antibacterial compounds may in particular be selected from the antibacterial compounds of less than 500 Da, for example tetrahydrocarbazoles, in particular 1-amino substituted tetrahydrocarbazoles (such as those described in particular by Reithuber et al., PNAS Nov. 23, 2021 118 (47) e2108244118), and the antibacterial peptides, such as for example described by Zhang et al. (Military Med Res 8, 48 (2021)).

All the embodiments defined previously are also applied here, alone or in combination.

According to a particular embodiment, all or part of these aliphatic polyamines are linked to the compound of interest by one or more non-covalent interactions, in particular weak interactions.

According to a particular embodiment, all or part of these aliphatic polyamines are linked to the compound of interest by a covalent bond, in particular via a bonding group.

According to a particular embodiment, the material is a fluorocarbon polymer in which part of the —F atoms are substituted by a group of formula (I):

—NH—R—Z (I),

in which R is a linear or branched C₂-C₁₂ diyl alkane, and:
R is substituted by one or two —NH₂ groups, or
R is substituted by —NH₂ group, and one of the carbon atoms of R is replaced by a nitrogen atom,
Z is carried by a nitrogen atom as defined above and is selected from the polysaccharides, in particular the polysaccharides consisting of or comprising at least one osamine unit, in particular chitosans or chitins, the polymers consisting of or comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, Z being optionally linked to R through a bonding group.

According to a particular embodiment, the material is an aromatic carbon material of which part of the carbon atoms carry a group of formula (I):

—NH—R—Z (I),

in which R is a linear or branched C₂-C₁₂ diyl alkane, and:
R is substituted by one or two —NH₂ groups, or
R is substituted by a —NH₂ group, and one of the carbon atoms of R is replaced by a nitrogen atom,
Z is carried by a nitrogen atom as defined above and is selected from the polysaccharides, in particular the polysaccharides consisting of or comprising at least one osamine unit, in particular chitosans or chitins, the polymers consisting of or comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, Z being optionally linked to R through a bonding group.

According to a particular embodiment, the material is a boron-based ceramic material, in which part of the boron atoms carry a group of formula (I):

—NH—R—Z (I),

in which R is a linear or branched C₂-C₁₂ diyl alkane, and:
R is substituted by one or two —NH₂ groups, or
R is substituted by a —NH₂ group, and one of the carbon atoms of R is replaced by a nitrogen atom.
Z is carried by a nitrogen atom as defined above and is selected from the polysaccharides, in particular the polysaccharides consisting of or comprising at least one osamine unit, in particular chitosans or chitins, the polymers consisting of or comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, Z being optionally linked to R through a bonding group.

By «bonding group» is meant in particular any group making it possible to link the group R to the residue Z. It may be a group consisting of or comprising a chain, in particular a C₁-C₂₀ alkyl or a PEG chain, said chain optionally carrying at its ends groups making it possible to link the group R and the residue Z, respectively. These groups can be selected from the esters, ethers, ketones, amines, imines, amides, triazines, etc.

According to another aspect, the invention concerns the use of a modified material as defined above, for the preparation of a functionalized material as defined above.

All the embodiments defined previously are also applied here, alone or in combination.

According to another aspect, the invention concerns a method for preparing a functionalized material, in particular as defined above, comprising the following steps:
a step (i) of bringing into contact a material selected from the fluorocarbon polymers, the aromatic carbon materials and the boron-based ceramic materials, with a composition consisting of or comprising an alkali metal and an aliphatic polyamine selected from the aliphatic diamines having two primary amines and the aliphatic triamines having two or three primary amines, or by a phosphoramide, to obtain a modified material;
optionally, a step (ii) of rinsing the modified material obtained at the end of step (i) with a solvent consisting of or comprising an alcohol, in particular ethanol, this step (ii) being optionally followed by a step (ii′) of rinsing with a solvent consisting of or comprising water;
a step (iii) of bringing into contact the modified material obtained at the end of step (i), (ii) or (ii′) with a compound selected from the polysaccharides, in particular the polysaccharides consisting of or comprising at least one osamine unit, in particular chitosans or chitins, polymers consisting of or comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, optionally in the presence of a bifunctional compound capable of forming a bonding group.

According to another aspect, the invention concerns a method for preparing a material as defined above, which is a fluorocarbon polymer, comprising the following steps:
a step (i) of bringing into contact a fluorocarbon polymer with a composition consisting of or comprising an alkali metal and an aliphatic polyamine selected from the aliphatic diamines having two primary amines and the aliphatic triamines having two or three primary amines, or by a phosphoramide, to obtain said polymer in which part of the —F atoms is substituted by said aliphatic polyamine or said phosphoramide;
optionally, a step (ii) of rinsing the polymer obtained at the end of step (i) with a solvent consisting of or comprising an alcohol, in particular ethanol, this step (ii) being optionally followed by a step (ii′) of rinsing with a solvent consisting of or comprising water;
a step (iii) of bringing into contact the polymer obtained at the end of step (i), (ii) or (ii′) with a compound selected from the polysaccharides, in particular the polysaccharides consisting of or comprising at least one osamine unit, in particular chitosans or chitins, the polymers consisting of or comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, optionally in the presence of a bifunctional compound capable of forming a bonding group, for example the glutaraldehyde.

According to another aspect, the invention concerns a method for preparing a material as defined above, which is an aromatic carbon material, comprising the following steps:
a step (i) of bringing into contact an aromatic carbon material with a composition consisting of or comprising an alkali metal and an aliphatic polyamine selected from the aliphatic diamines having two primary amines and the aliphatic triamines having two or three primary amines, or by a phosphoramide, to obtain said material of which part of the —C atoms is covalently linked to said aliphatic polyamine;
optionally, a step (ii) of rinsing the material obtained at the end of step (i) with a solvent consisting of or comprising an alcohol, in particular ethanol, this step (ii) being optionally followed by a step (ii′) of rinsing with a solvent consisting of or comprising water;
a step (iii) of bringing into contact the material obtained at the end of step (i), (ii) or (ii′) with a compound selected from the polysaccharides, in particular the polysaccharides consisting of or comprising at least one osamine unit, in particular chitosans or chitins, the polymers consisting of or comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, optionally in the presence of a bifunctional compound capable of forming a bonding group.

According to another aspect, the invention concerns a method for preparing a material as defined above, which is a boron-based ceramic material, comprising the following steps:
a step (i) of bringing into contact a boron-based ceramic material with a composition consisting of or comprising an alkali metal and an aliphatic polyamine selected from the aliphatic diamines having two primary amines and the aliphatic triamines having two or three primary amines, or by a phosphoramide, to obtain said material of which part of the —B atoms is covalently linked to said aliphatic polyamine;
optionally, a step (ii) of rinsing the material obtained at the end of step (i) with a solvent consisting of or comprising an alcohol, in particular ethanol, this step (ii) being optionally followed by a step (ii′) of rinsing with a solvent consisting of or comprising water;
a step (iii) of bringing into contact the material obtained at the end of step (i), (ii) or (ii′) with a compound selected from the polysaccharides, in particular the polysaccharides consisting of or comprising at least one osamine unit, in particular chitosans or chitins, the polymers consisting of or comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, optionally in the presence of a bifunctional compound capable of forming a bonding group.

All the embodiments defined previously are also applied here, alone or in combination.

When step (i) involves a phosphoramide, the compound selected from the polysaccharides, in particular the polysaccharides consisting of or comprising at least one osamine unit, in particular chitosans or chitins, the polymers consisting of or comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, is in particular halogenated, for example chlorinated. It may in particular be a halogenated chitosan.

### FIGURES

FIG. 1 shows the IR-ATR spectra on diamond crystal before (A) and after functionalization (B) of PTFE, with 1,3-diaminopropane, in the presence of lithium, according to Example 1.

FIG. 2 relates to the Raman spectrum and after functionalization of carbon nanotubes, with ethylenediamine, in the presence of lithium, according to Example 4.

### EXAMPLES

### Example 1: Modification of PTFE and ePTFE According to the Invention

The following steps were carried out in a glove box under an argon atmosphere:
10 square ePTFE samples of 1×1 cm were introduced into a 40 mL vial containing 10 mL (9.00 g) of ethylenediamine and 0.05 g of lithium (Li/EDA mass ratio=0.0056, ePTFE/EDA mass ratio=0.129);
The mixture thus obtained was stirred with a magnetic bar covered with glass, using a magnetic stirrer for 17 to 18 hours;
The ePTFE samples thus obtained were collected with a glass spatula in a crystallizer, then taken out of the glove box.

The following steps were then carried out directly, under a fume hood:
the samples were placed in an excess of pure ethanol and treated with ultrasound for 10 minutes;
the ethanol was removed then the operation was repeated twice with ultrapure water (Millipore);
the ePTFE samples thus modified were dried in a petri dish under a hood at room temperature. Diethylenetriamine-modified ePTFE samples were obtained similarly. Furthermore, modified PTFE samples, particularly using 1,3-diaminopropane or hexamethylphosphoramide, were similarly obtained.

The modified ePTFE and PTFE samples thus obtained were analyzed by IR-ATR spectroscopy, using different crystals/prisms, in which diamond one which makes it possible to probe, over a small thickness, the first functionalization layers.

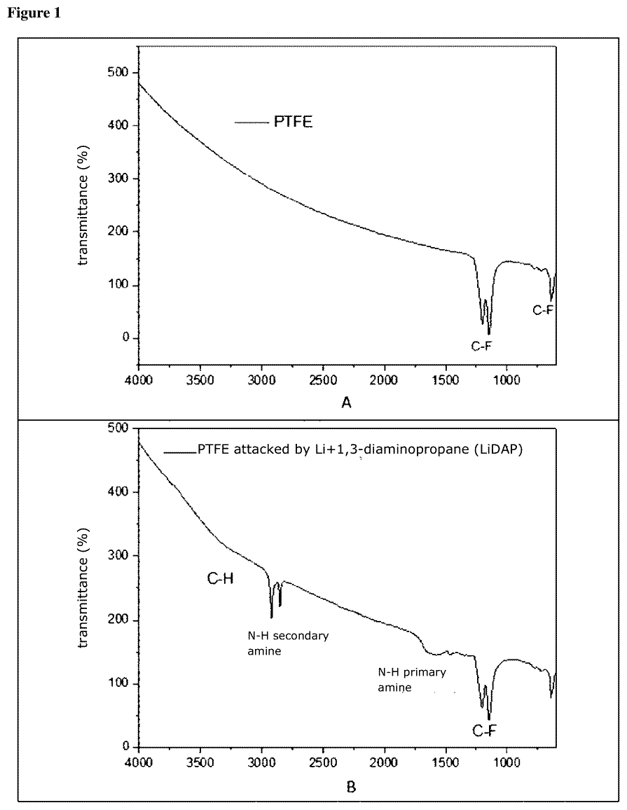

For example, FIG. 1 shows the IR-ATR spectra on diamond crystal before and after functionalization with 1,3-diaminopropane according to the invention of PTFE.

The IR characterization shows that the samples have indeed been chemically modified, as evidenced in particular by the presence of the characteristic IR bands which are the —CH₂, —NH and —NH₂ bands on the spectra of the modified polymers. There is indeed an irreversible modification of these polymer materials and the formation of covalent bonds between the carbon of the polymer and the amine of the polyamine or HMPA.

The products of the invention were also demonstrated by XPS spectroscopy

### Example 2: Functionalization of PTFE According to the Invention

Chitosan was grafted to the ePTFE, as follows:
Solubilization of chitosan: in a 30 mL flask, 0.200 g of chitosan and 0.094 mL of 10⁻⁶ M acetic acid were added, then the flask was filled with water up to the gauge mark and left to shake for 10 min;

The reaction mixture was then filtered;
the 10 samples of modified ePTFE as obtained at the end of Example 1 were added, followed by 0.30 mL of 25% glutaraldehyde solution.
After stirring for 2 hours, the medium was discarded and the samples rinsed in an excess of ultrapure water (Millipore), 3 times for 10 minutes with stirring.

PVP (in this case without the glutaraldehyde treatment step) and PEI were also successfully grafted, with a protocol similar to that above.

The IR characterization before and after functionalization according to the invention shows that in all cases, the samples were successfully functionalized.

The functionalized samples of the invention were also demonstrated by XPS spectroscopy.

### Example 3: Modification of Nafion According to the Invention

Nafion samples modified, for example by ethylenediamine or diethylenetriamine, were successfully obtained, in a manner similar to those of Example 1.

### Example 4: Other Modifications According to the Invention

Samples of boron nitride (single-wall BN) and single-wall carbon nanotubes (SWCNT) were also modified according to the invention, and characterized by IR-ATR and XPS analyses.

Single-wall carbon nanotubes (Sigma-Aldrich) were in particular treated according to the invention with ethylenediamine in the presence of lithium, according to a procedure similar to that presented in Example 1.

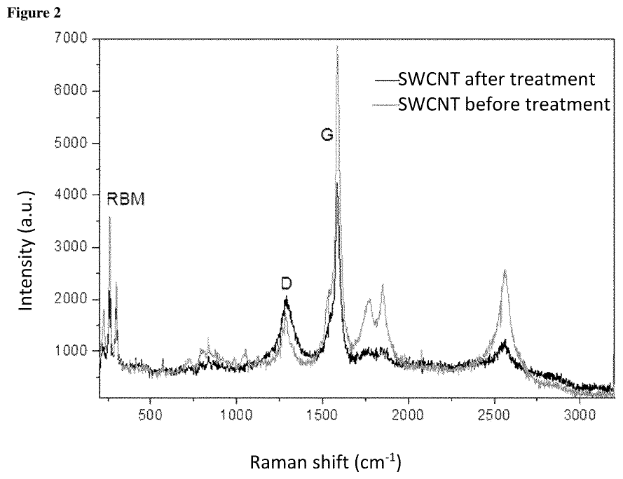

The carbon nanotubes thus modified were analyzed by Raman spectroscopy (FIG. 2). The peaks of the D, G and RBM bands are irreversibly modified. emphasizing that the carbon nanotubes of the invention are functionalized by ethylenediamine.

1. A material selected from fluorocarbon polymers, aromatic carbon materials and boron-based ceramic materials, wherein:
(a) the material is a fluorocarbon polymer and all or part of the —F atoms for the fluorocarbon polymers are substituted by an aliphatic polyamine selected from the aliphatic diamines having two primary amines and the aliphatic triamines having two or three primary amines, or a phosphoramide;
(b) the material is an aromatic carbon material and a part of the carbon atoms thereof carries an aliphatic polyamine selected from the aliphatic diamines having two primary amines and the aliphatic triamines having two or three primary amines, or a phosphoramide; or
(c) the material is a boron-based ceramic material and a part of the boron atoms for the boron-based ceramic materials carries;
an aliphatic polyamine selected from the aliphatic diamines having two primary amines and the aliphatic triamines having two or three primary amines, or a phosphoramide.

2. The material according to claim 1, which is a fluorocarbon polymer in which all or part of the —F atoms are substituted by a group of formula (I):
—NH—R (I),
in which R is a linear or branched C₂-C₁₂ alkyl, and:
R is substituted by one or two —NH₂ groups, or
R is substituted by a —NH₂ group, and one of the carbon atoms of R is replaced by a nitrogen atom.

3. The material according to claim 1, wherein the material is a fluorocarbon selected from the group consisting of polytetrafluoroethylene (PTFE), perfluorosulfonic acid polymer (PFSA), poly (vinyl fluoride) (PVF), poly(vinylidene fluoride) (PVDF), polychlorotrifluoroethylene (PCTFE), perfluoroalkoxy (PFA), fluorinated ethylene propylene (FEP), ethylene tetrafluoroethylene (ETFE), polyethylenechlorotrifluoroethylene (ECTFE), perfluoropolyether (PFPE), perfluoropolyoxetane, and fluoroelastomers, said material being in particular polytetrafluoroethylene (PTFE), more particularly an expanded polytetrafluoroethylene (ePTFE), or a perfluorosulfonic acid.

4. (canceled)

5. A method for preparing a material as defined in claim 1, comprising:
(i) bringing into contact a material selected from the fluorocarbon polymers, the aromatic carbon materials and the boron-based ceramic materials, with a composition comprising an alkali metal and an aliphatic polyamine selected from the aliphatic diamines having two primary amines and the aliphatic triamines having two or three primary amines, or a phosphoramide, to obtain said material.

6. The method according to claim 5, wherein the alkali metal is lithium or sodium.

7. The method according to claim 5, wherein (i) is carried out at a temperature of 10° C. to 80° C., in particular at a temperature of 15 to 25° C., in particular around 20° C.

8. The method according to claim 5, wherein the alkali metal/aliphatic polyamine molar ratio is comprised from 0.1 to 0.9, in particular from 0.2 to 0.8, or from 0.3 to 0.7, or from 0.4 to 0.6, this ratio being in particular around 0.5.

9. The material according to claim 1, wherein all or part of said aliphatic polyamines are further linked, in particular by crosslinking, to a compound of interest independently selected from the polysaccharides, in particular the polysaccharides consisting of or comprising at least one osamine unit, in particular chitosans or chitins, the polymers consisting of or comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds.

10. The method for preparing a material as defined in claim 9, which is a fluorocarbon polymer, comprising:
(i) bringing into contact a fluorocarbon polymer with a composition comprising an alkali metal and an aliphatic polyamine selected from the aliphatic diamines having two primary amines and the aliphatic triamines having two or three primary amines, or a phosphoramide, to obtain said polymer in which part of the —F atoms is substituted by said aliphatic polyamine;
optionally, (ii) rinsing the polymer obtained at the end of (i) with a solvent comprising an alcohol, in particular ethanol, optional step (ii) being optionally followed by (ii′) rinsing with a solvent comprising water; and
(iii) bringing into contact the polymer obtained at the end of (i), (ii) or (ii′) with a compound selected from the polysaccharides, in particular the polysaccharides consisting of or comprising at least one osamine unit, in particular chitosans or chitins, the polymers comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, optionally in the presence of a bifunctional compound capable of forming a bonding group.

11. The method for preparing a material as defined in claim 9, which is an aromatic carbon material, comprising:
(i) bringing into contact an aromatic carbon material with a composition comprising an alkali metal and an aliphatic polyamine selected from the aliphatic diamines having two primary amines and the aliphatic triamines having two or three primary amines, or a phosphoramide, to obtain said material of which part of the —C atoms is covalently linked to said aliphatic polyamine;
optionally, (ii) rinsing the material obtained at the end of (i) with a solvent comprising an alcohol, in particular ethanol, optional step (ii) being optionally followed by (ii′) rinsing with a solvent consisting of or comprising water; and
(iii) bringing into contact the material obtained at the end of (i), (ii) or (ii′) with a compound selected from the polysaccharides, in particular the polysaccharides comprising at least one osamine unit, in particular chitosans or chitins, the polymers comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, optionally in the presence of a bifunctional compound capable of forming a bonding group.

12. The method for preparing a material as defined in claim 9, which is a boron-based ceramic material, comprising:
(i) bringing into contact a boron-based ceramic material with a comprising an alkali metal and an aliphatic polyamine selected from the aliphatic diamines having two primary amines and the aliphatic triamines having two or three primary amines, or a phosphoramide, to obtain said material of which part of the —C atoms is covalently linked to said aliphatic polyamine;
optionally, (ii) rinsing the material obtained at the end of (i) with a solvent comprising an alcohol, in particular ethanol, optional step (ii) being optionally followed by (ii′) rinsing with a solvent consisting of or comprising water; and
(iii) bringing into contact the material obtained at the end of (i), (ii) or (ii′) with a compound selected from the polysaccharides, in particular the polysaccharides comprising at least one osamine unit, in particular chitosans or chitins, the polymers comprising at least one unit comprising a primary or secondary amine, or a lactam, in particular the polyethyleneimines (PEI), in particular the linear, branched or dendrimeric polyethyleneimines, the polyvinylpyrrolidones (PVP), and the antibacterial compounds, optionally in the presence of a bifunctional compound capable of forming a bonding group.
